(19) United States
(12) Patent Application Publication
(10) Pub. No.: US 2020/0193317 A1
(43) Pub. Date: Jun. 18, 2020

(54) METHOD, DEVICE AND COMPUTER PROGRAM FOR ESTIMATING TEST SCORE

(71) Applicant: RIIID INC., Seoul (KR)

(72) Inventors: Yeong Min CHA, Seongnam-si (KR); Jae We HEO, Seoul (KR); Young Jun JANG, Seoul (KR)

(73) Assignee: Riiid Inc., Seoul (KR)

(21) Appl. No.: 16/615,084

(22) PCT Filed: Jun. 8, 2017
(86) PCT No.: PCT/KR2017/005926

§ 371 Date: Nov. 19, 2019

(30) Foreign Application Priority Data
May 19, 2017 (KR) 10-2017-0062554

(51) Int. Cl. G06N 7/00; G06N 20/00; G06F 16/23; G09B 7/00

(52) U.S. Cl. CPC G06N 7/005; G06N 20/00; G06Q 50/20; G09B 7/00; G06F 16/2379

(57) ABSTRACT

The present invention relates to a method for estimating, by a learning data analysis server, a predicted score of a user for a test question, the method comprising: step a of establishing a question database including a plurality of questions, of collecting solving result data of a plurality of users for the questions, and of estimating a correct answer probability of a random user for a random question by using the solving result data; step b of establishing, from the question database, at least one set of mock test questions similar to a set of external test questions which has been set without using the question database; and step c of estimating, for the random user who has not solved the mock test question set, a predicted score for the mock test question set by using the correct answer probability of the user for each question constituting the mock test question set, and providing the estimated predicted score as a predicted score for the external test questions.

### TECHNICAL FIELD

The present disclosure relates to a method for estimating a test score of a specific user, and more particularly, to a method for estimating a predicted score of a specific user for an actual test by analyzing question-solving result data of a large number of users.

### BACKGROUND ART

Until now, predicted scores of testees for a specific test were generally estimated according to know-how of experts. For example, in the case of the college scholastic ability test, a mock test is established similar to an actual college scholastic ability test according to the expert's know-how, and the predicted score of the college scholastic ability test is predicted on the basis of results of students solving the mock test.

However, this method depends on subjective experience and intuition of the experts, so it is often very different from actual test results. For example, there are a lot of cases in which a student who has received a second-grade level in a mock test receives a completely different grade in an actual test. Furthermore, in order for students to find out even their incomplete predicted scores, a burden of having to directly solve many mock tests arises.

Thus, in the conventional Korean educational environment, the testee's predicted score for the actual test is not calculated mathematically. In order to obtain the predicted score, the testee must take a lot of mock tests. Also, the testee prepares the target test according to low-confidence predicted score information, which results in a problem that the learning efficiency is low.

### DETAILED DESCRIPTION OF THE INVENTION

### Technical Problem

Therefore, the present disclosure has been made in view of the above-mentioned problems, and an aspect of the present disclosure is to provide a method for estimating a predicted score of a target test without solving mock test questions for a specific test.

More specifically, another aspect of the present disclosure is to provide a method of establishing a modeling vector for questions and users, estimating a predicted score of a mock test question set established similar to actual test questions without the user having to solving the mock test question set, and providing the estimated predicted score as a predicted score of the actual test questions.

### Technical Solution

In accordance with an aspect of the present disclosure, a method for estimating a predicted score of a user for test questions by a learning data analysis server may include: step a of establishing a question database including a plurality of questions, of collecting solving result data of a plurality of users for the questions, and of estimating a correct answer probability of a random user for a random question by using the solving result data; step b of establishing, from the question database, at least one set of mock test questions similar to a set of external test questions which has been set without using the question database; and step c of estimating, for the random user who has not solved the mock test question set, a predicted score for the mock test question set by using the correct answer probability of the user for each question constituting the mock test question set, and providing the estimated predicted score as a predicted score for the external test questions.

As described above, according to the present disclosure, it is possible to estimate an actual test score without a user having to solve a mock test question set.

### BRIEF DESCRIPTION OF THE DRAWINGS

FIG. 1 is a flowchart illustrating a process of estimating a test score in a data analysis framework according to an embodiment of the present disclosure.

### MODE FOR CARRYING OUT THE INVENTION

The present disclosure is not limited to the description of the embodiments described below, and it is obvious that various modifications can be made without departing from the technical gist of the present disclosure. In the following description, well-known functions or constructions are not described in detail since they would obscure the disclosure in unnecessary detail.

In the accompanying drawings, the same components are denoted by the same reference numerals. In the accompanying drawings, some of the elements may be exaggerated, omitted or schematically illustrated. It is intended to clearly illustrate the gist of the present disclosure by omitting unnecessary explanations not related to the gist of the present disclosure.

With the recent spread of IT devices, it is becoming easier to collect data for user analysis. If user data can be sufficiently collected, the analysis of the user becomes more precise and contents in a form most suitable for the corresponding user can be provided.

With this trend, there is a high need for precise user analysis, especially in the education industry. As a simple example, when it can be highly reliably predicted that a student who intends to go to a specific college will obtain 50 points in a language area and 80 points in a foreign language area of the scholastic ability test, the corresponding student will be able to refer to the college's application guidelines and decide which subject to focus on.

In order to estimate test scores, students have traditionally followed a method of solving mock tests, which are established similar to a target test by experts, several times. However, it is difficult to see the practice itself of the testee solving the mock test as efficient study. Since the mock test is established on the basis of a similarity to the actual test, it is carried out irrespective of the testee's ability. In other words, the mock test is aimed at confirming his/her position among all the students by estimating the test scores, and it does not provide questions constituted for the testee's learning.

Therefore, individual students solve even questions that they knew through mock tests several times. In addition, since conventional mock tests are established according to know-how of experts, it is impossible to mathematically calculate whether the mock tests are similar to actual tests, that is, a similarity to the actual tests, and a student's predicted score estimated through the mock test has a big difference from the actual score.

The present disclosure is intended to solve such a problem as described above. A data analysis server according to an embodiment of the present disclosure is to provide a method of applying a machine learning framework to learning data analysis to exclude human intervention in data processing and to estimate test scores.

According to an embodiment of the present disclosure, a user can predict a test score even without taking a mock test. More specifically, in accordance with an embodiment of the present disclosure, a mock test that is mathematically similar to an actual test can be established through a question database of a data analysis system. Furthermore, a correct answer rate for questions can be estimated using a modeling vector for users and questions even without taking a mock test established through a question database, thereby calculating a predicted score of a target test with high reliability.

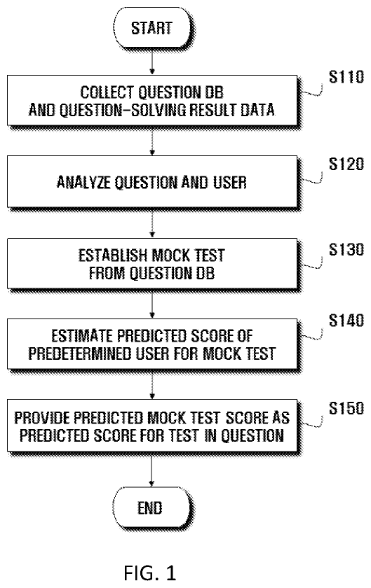

FIG. 1 is a flowchart illustrating a method for estimating an actual test score of a random user in a learning data analysis framework according to an embodiment of the present disclosure.

Operation 110 and operation 120 are prerequisites for estimating a predicted score of an actual test for each user in a data analysis system.

According to the embodiment of the present disclosure, in operation 110, question-solving result data of all users for overall questions stored in a database may be collected.

More specifically, the data analysis server may establish a question database, and the question-solving result data of all users for overall questions belonging to the question database may be collected.

For example, the data analysis server may build a database for various available questions and may collect the question-solving result data by collecting results of users solving the corresponding questions. The question database includes listening test questions and can be provided in the form of text, image, audio, and/or video.

At this time, the data analysis server may establish the collected question-solving result data in the form of a list of users, questions, and results. For example, Y (u, i) denotes a result obtained by solving a question i by a user u, and a value of 1 may be given when the answer is correct and a value of 0 may be given when the answer is incorrect.

Furthermore, in operation 120, the data analysis server according to the embodiment of the present disclosure establishes a multi-dimensional space composed of users and questions, and assigns values to the multi-dimensional space on the basis of whether the answer of the user is correct or incorrect, thereby calculating a vector for each user and each question. At this time, features included in the user vector and the question vector should be construed as not being limited.

Meanwhile, although not shown separately in FIG. 1, the data analysis server can estimate a probability that the answer of a random user for a random question is correct, that is, a correct answer rate, using the user vector and the question vector.

At this time, the correct answer rate can be calculated by applying various algorithms to the user vector and the question vector, and an algorithm for calculating the correct answer rate in interpreting the present disclosure is not limited.

For example, the data analysis server may calculate a correct answer rate of a user for a corresponding question by applying, to the user vector value and the question vector, a sigmoid function that sets parameters to estimate the correct answer rate.

As another example, the data analysis server may estimate a degree of understanding of a specific user for a specific question by using a vector value of the user and a vector value of the question, and may estimate a probability that the answer of the specific user for the specific question is correct using the estimated degree of understanding.

For example, if values of a first row of a user vector are [0, 0, 1, 0.5, 1], it can be interpreted that a first user does not understand first and second concepts at all, completely understands third and fifth concepts, and half understands a fourth concept.

Further, if values of a first row of a question vector are [0, 0.2, 0.5, 0.3, 0], it can be interpreted that a first question does not include a first concept at all, includes a second concept by about 20%, includes a third concept by about 50%, and includes a fourth concept by about 30%.

At this time, a degree of understanding of the first user for the first question can be calculated as 0×0+0×0.2+1×0.5+0.5×0.5+1×0=0.75. That is, the first user may be estimated to understand the first question by 75%.

However, a degree of understanding of a user for a specific question and a probability that the answer of the user for the specific question is correct are not the same. In the above example, assuming that the first user understands the first question by 75%, when the first user actually solves the first question, it is necessary to calculate a probability that the answer of the first user for the first question is correct.

To this end, the methodology used in psychology, cognitive science, pedagogy, and the like may be introduced to estimate a relationship between the degree of understanding and the correct answer rate. For example, the degree of understanding and the correct answer rate can be estimated in consideration of multidimensional two-parameter logistic (M2PL) latent trait model devised by Reckase and McKinely, or the like.

However, according to the present disclosure, it is sufficient to calculate a correct answer rate of a user for a specific question by applying the conventional technique capable of estimating the relationship between the degree of understanding and the correct answer rate. It should be noted that the present disclosure cannot be construed as being limited to a methodology for estimating the relationship between the degree of understanding and the correct answer rate.

Next, in operation 130, the data analysis server may establish a mock test similar to a target test for estimating a test score using the question database. At this time, it is more appropriate that a plurality of mock tests for a specific test is provided.

It is not easy to calculate a modeling vector for each of actual test questions, since an actual test is basically made outside the question database. Therefore, when a mock test similar to a corresponding test is generated using the question database in which the modeling vector is calculated in advance, a predictive score of the mock test can be replaced with the predicted score of the actual test.

According to the embodiment of the present disclosure, a mock test can be established in the following manner.

A first method of establishing a mock test according to the embodiment of the present disclosure is to establish a question set in such a manner that an average score of all users for a mock test is within a random range using an average correct answer rate of all users for each question in a database.

For example, when referring to the statistics of a language proficiency test, if an average score of all testees in the test is 67 points to 69 points, the data analysis server may establish a question set in such a manner that an average score of a mock test is also within the range of 67 points to 69 points.

At this time, the mock test question set can be established considering the question type distribution of the target test. For example, when referring to the statistics of the language proficiency test, if an actual test is given as about 20% for a first type, about 30% for a second type, about 40% for a third type, and about 10% for a fourth type, the question type distribution of the mock test can be established similar to that of the actual test.

To this end, according to the embodiment of the present disclosure, it is possible to add index information to the question database by previously generating a label for the question type.

For example, the data analysis server may predefine labels of questions that can be classified into a random type, may cluster the questions by learning the characteristics of a question model that follows the corresponding question type, and may assign labels for the question type to the clustered question group, thereby generating index information.

As another example, the data analysis server may cluster questions using modeling vectors of the questions without predefining a label for a question type, and may interpret the meaning of the clustered question group to assign the label for the question type, thereby generating index information.

A second method of establishing a mock test according to the embodiment of the present disclosure is to use actual score information of arbitrary users for a target test.

For example, in the previous example for the language proficiency test, if actual scores of users A, B, and C who took the test were 60, 70, and 80, respectively, a question set of a mock test may be established in such a manner that estimated scores of the mock test calculated by applying previously calculated correct answer rates of the users A, B, and C are 60, 70, and 80, respectively.

According to the embodiment that establishes the question set in such a manner that the estimated score of the mock test approaches the actual score, a similarity between the mock test and the actual test can be mathematically calculated using score information of a user who took the actual test. Therefore, it is possible to increase the reliability of the mock test, that is, the reliability that the score of the mock test is closer to the score of the actual test.

At this time, according to the embodiment of the present disclosure, question type distribution information of the target test can be applied to establish a mock test question set, and other statistically analyzed information can be applied.

Meanwhile, although not separately shown in FIG. 1, the data analysis server can adjust points of the questions in a process of establishing the mock test question set. This is because separate point information is not assigned to questions belonging to the question database, but different points are assigned to each of questions in an actual test.

In general, in an actual test, a high point is assigned to a difficult question and a low point is assigned to an easy question. In analyzing this, points of actual questions are assigned in consideration of an average correct answer rate of a corresponding question, the number of concepts constituting the question, a length of question text, etc., and a predetermined point may be assigned according to the question type.

Therefore, the data analysis server according to the embodiment of the present disclosure may assign points of respective questions constituting the mock test question set by reflecting at least one of the average correct answer rate of the corresponding question, the number of concepts constituting the corresponding question, a length of question text, and question type information.

To this end, although not separately shown in FIG. 1, the data analysis server may generate a metadata set for a minimum learning element by listing learning elements and/or subjects of a corresponding subject in a tree structure to generate a label for the concept of a corresponding question, and may classify the minimum learning element into groups suitable for analysis, thereby generating index information for the concept constituting the corresponding question.

In particular, according to the embodiment of the present disclosure, points of respective questions constituting a question set may be assigned in such a manner that actual scores of users who actually took the target test approach estimated scores of the users for the mock test question set.

In operation 140, if the mock test question set having a high similarity to the actual test is established, the data analysis server according to the embodiment of the present disclosure may estimate a predicted score of each user for the mock test. The score of the mock test may be estimated as the score of the actual test on the basis of the assumption that the actual test and the mock test are similar to each other.

In particular, according to the embodiment of the present disclosure, there is a characteristic that the score of the mock test can be estimated with high reliability without a user having to directly solve the questions of the mock test.

The mock test according to the embodiment of the present disclosure may be established with questions included in the question database, and the correct answer rate of a user for each question belonging to the database may be calculated in advance as described above. Therefore, it is possible to estimate a predicted score of a corresponding user for the mock test by using the correct answer rates of individual users for all questions constituting the mock test.

In this case, according to the embodiment of the present disclosure, a plurality of question sets of the mock test for estimating a random test score may be established, and an estimated score of a specific user for a plurality of mock tests may be averaged to estimate a predicted score of the corresponding user for an actual test.

The embodiments of the present disclosure disclosed in the present specification and drawings are intended to be illustrative only and not for limiting the scope of the present disclosure. It will be apparent to those skilled in the art that other modifications on the basis of the technical idea of the present disclosure are possible in addition to the embodiments disclosed herein.

1. A method for estimating, by a learning data analysis server, a predicted score of a user for test questions, the method comprising:
step a of establishing a question database including a plurality of questions, of collecting solving result data of a plurality of users for the questions, and of estimating a correct answer probability of a random user for a random question by using the solving result data;
step b of establishing, from the question database, at least one set of mock test questions similar to a set of external test questions which has been set without using the question database; and
step c of estimating, for the random user who has not solved the mock test question set, a predicted score for the mock test question set by using the correct answer probability of the user for each question constituting the mock test question set, and providing the estimated predicted score as a predicted score for the external test questions.

2. The method as claimed in claim 1, wherein step b comprises:
establishing the mock test question set, using an average correct answer rate of all users for respective questions constituting the mock test question set, in such a manner that an average score of the all users for the mock test question set corresponds to a preset range.

3. The method as claimed in claim 2, wherein step b comprises:
establishing the mock test question set to follow question type distribution information of the previously calculated external test question set.

4. The method as claimed in claim 1, wherein step b comprises:
obtaining actual score information of at least one user for the external test question set; and
establishing the mock test question set in such a manner that the predicted score of the user for the mock test question set approaches the actual score information.

5. An apparatus for estimating a predicted score of a user for test questions, the apparatus comprising:
a question database configured to include a plurality of questions; and
a control unit configured to collect solving result data of a plurality of users for the questions, to estimate a correct answer probability of a random user for a random question by using the solving result data, to establish, from the question database, at least one set of mock test questions similar to a set of external test questions which has been set without using the question database, to estimate, for the random user who has not solved the mock test question set, a predicted score for the mock test question set by using the correct answer probability of the user for each question constituting the mock test question set, and to provide the estimated predicted score as a predicted score for the external test questions.
